(19) United States
(12) Patent Application Publication
(10) Pub. No.: US 2022/0147852 A1
(43) Pub. Date: May 12, 2022

(54) MITIGATING PARTIALITY IN REGRESSION MODELS

(71) Applicant: International Business Machines Corporation, Armonk, NY (US)

(72) Inventors: Ravi Chandra Chamarthy, Hyderabad (IN); Manish Anand Bhide, Hyderabad (IN); Prateek Goyal, Indore (IN)

(21) Appl. No.: 17/093,854

(22) Filed: Nov. 10, 2020

(51) Int. Cl. G06N 7/00; G06N 20/00; G06K 9/62

(52) U.S. Cl. CPC G06N 7/005; G06K 9/6268; G06N 20/00

(57) ABSTRACT

A computer device receives historical prediction data, where the historical prediction data includes historical data and corresponding predictions generated for the historical data by a regression machine learning model. The computing device identifies undesired predictions in the historical prediction data based, at least in part, on a perturbation analysis, where the perturbation analysis includes modifying an attribute of the historical data and using the regression machine learning model to generate predictions for the historical data with the modified attribute. The computing device trains a binary classification model to classify predictions as undesired, using the historical prediction data and the identified undesired predictions as training data. The computing device generates a prediction for a new data entry utilizing the regression machine learning model and the binary classification model.

### BACKGROUND OF THE INVENTION

The present invention relates generally to the field of large dataset analysis and more particularly to analyzing large datasets using regression machine learning models.

Generally, with large datasets, computer decision algorithms may tend to select a particular group of data entries routinely over other groups of data entries, based on particular values of particular attributes, for example. One type of computer decision algorithm is a regression-based model, which produces real or continuous outputs for large datasets.

### SUMMARY

Embodiments of the present invention provide a method, system, and program product.

A first embodiment encompasses a method. One or more processors receive historical prediction data, where the historical prediction data includes historical data and corresponding predictions generated for the historical data by a regression machine learning model. One or more processors identify undesired predictions in the historical prediction data based, at least in part, on a perturbation analysis, where the perturbation analysis includes modifying an attribute of the historical data and using the regression machine learning model to generate predictions for the historical data with the modified attribute. One or more processors train a binary classification model to classify predictions as undesired, using the historical prediction data and the identified undesired predictions as training data. One or more processors generate a prediction for a new data entry utilizing the regression machine learning model and the binary classification model.

A second embodiment encompasses a computer program product. The computer program product includes one or more computer-readable storage media and program instructions stored on the one or more computer-readable storage media. The program instructions include program instructions to receive historical prediction data, where the historical prediction data includes historical data and corresponding predictions generated for the historical data by a regression machine learning model. The program instructions include program instructions to identify undesired predictions in the historical prediction data based, at least in part, on a perturbation analysis, where the perturbation analysis includes modifying an attribute of the historical data and using the regression machine learning model to generate predictions for the historical data with the modified attribute. The program instructions include program instructions to train a binary classification model to classify predictions as undesired, using the historical prediction data and the identified undesired predictions as training data. The program instructions include program instructions to generate a prediction for a new data entry utilizing the regression machine learning model and the binary classification model.

A third embodiment encompasses a computer system. The computer system includes one or more computer processors, one or more computer-readable storage media, and program instructions stored on the computer-readable storage media for execution by at least one of the one or more processors. The program instructions include program instructions to receive historical prediction data, where the historical prediction data includes historical data and corresponding predictions generated for the historical data by a regression machine learning model. The program instructions include program instructions to identify undesired predictions in the historical prediction data based, at least in part, on a perturbation analysis, where the perturbation analysis includes modifying an attribute of the historical data and using the regression machine learning model to generate predictions for the historical data with the modified attribute. The program instructions include program instructions to train a binary classification model to classify predictions as undesired, using the historical prediction data and the identified undesired predictions as training data. The program instructions include program instructions to generate a prediction for a new data entry utilizing the regression machine learning model and the binary classification model.

### BRIEF DESCRIPTION OF THE SEVERAL VIEWS OF THE DRAWINGS

FIG. 1 is a functional block diagram illustrating a computing environment, in which a computing device mitigates partiality within a regression learning model, in accordance with an exemplary embodiment of the present invention.

FIG. 2 illustrates operational processes of executing a system to mitigate partiality within a regression learning model, on a computing device within the environment of FIG. 1, in accordance with an exemplary embodiment of the present invention.

FIG. 3 illustrates operational processes of executing a system to optimize the mitigation of partiality within a regression learning model, on a computing device within the environment of FIG. 1, in accordance with an exemplary embodiment of the present invention.

FIG. 4 depicts a cloud computing environment, according to at least one embodiment of the present invention.

FIG. 5 depicts abstraction model layers, according to at least on embodiment of the present invention.

FIG. 6 depicts a block diagram of components of one or more computing devices within the computing environment depicted in FIG. 1, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the present invention recognize that in a modernized digital climate artificial intelligence is capable of reviewing and making determinations for large quantities of datasets, where, in the case of regression-based artificial intelligence models, a determination may take the form of a value-based output, or prediction. Embodiments of the present invention further recognize that incorrect predictions can create a disparate impact on certain groups of data entries, and can negatively influence subsequent predictions. Embodiments of the present invention use perturbation analysis to detect such a disparate impact in a regression model prediction, and further use the results of that analysis to build a partiality detection model that can be used in combination with the regression model to mitigate potential partiality/bias, thus providing an equally favorable output determination for each group of data entries.

Embodiments of the present invention provide technological improvements over known regression modelling systems in several meaningful ways. For example, various embodiments of the present invention improve over existing systems by providing more useful results—i.e., predictions that are less biased/partial are more useful to end users and are thus improvements over existing systems. But further, various embodiments of the present invention also provide important improvements to the technological operations of the underlying systems generating these predictions. For example, generating predictions for large sets of data (for example, in “Big Data” environments) can be a very processor and memory intensive operation, and embodiments of the present invention, by using the regression modeling improvements of embodiments of the present invention, reduce the number of unacceptable predictions generated by such algorithms, thus decreasing the amount of predictions that need to be discarded which, in turn, results in a more efficient consumption of computing resources.

The present invention will now be described in detail with reference to the Figures.

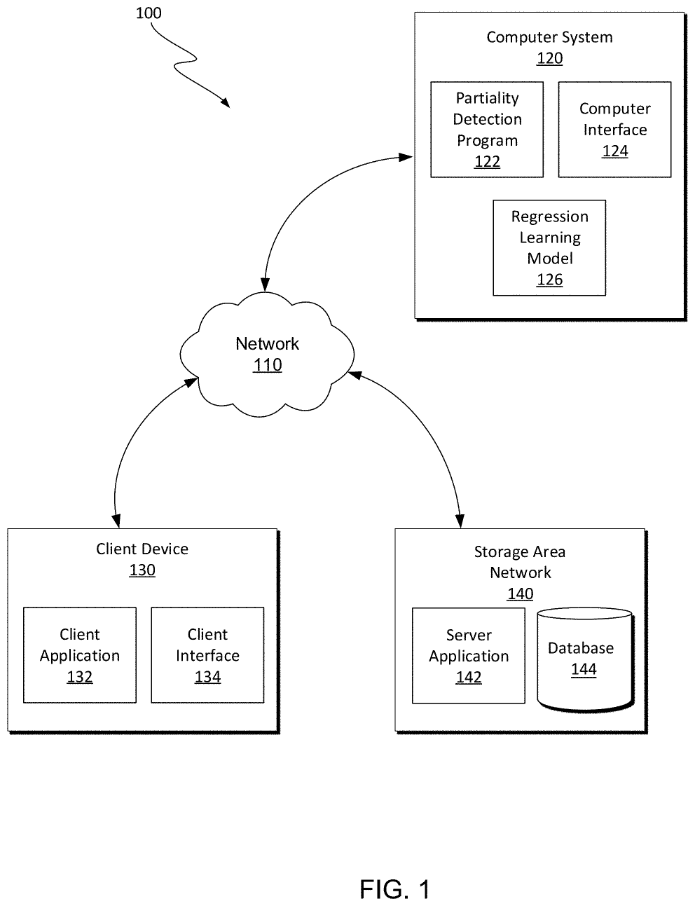

FIG. 1 is a functional block diagram illustrating computing environment, generally designated 100, in accordance with one embodiment of the present invention. computing environment 100 includes computer system 120, client device 130, and storage area network (SAN) 140 connected over network 110. Computer system includes partiality detection program 122, computer interface 124, and regression learning model 126. Client device 130 includes client application 132 and client interface 134. Storage area network (SAN) 140 includes server application 142 and database 144.

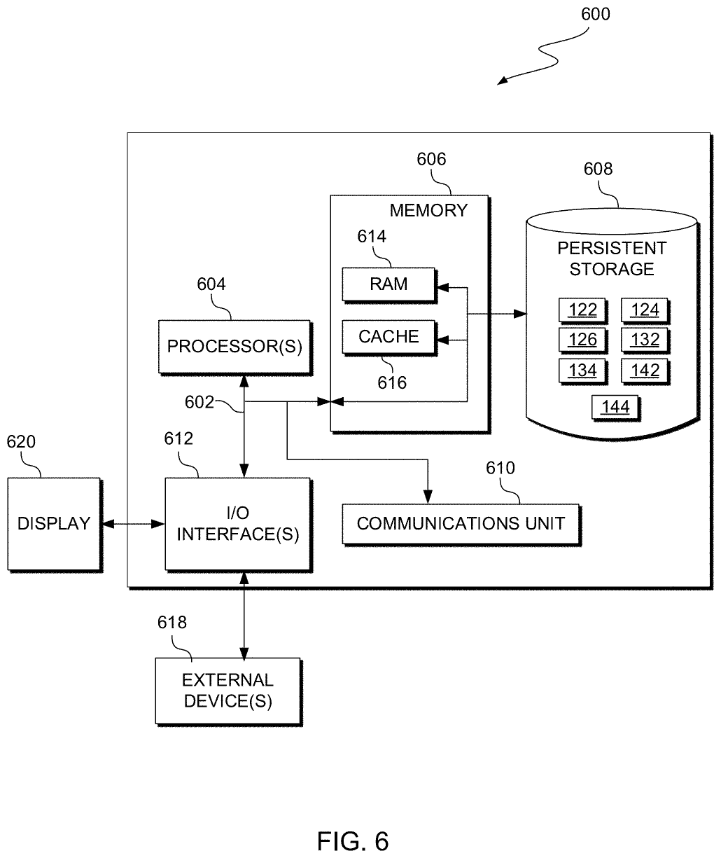

In various embodiment of the present invention, computer system 120 is a computing device that can be a standalone device, a server, a laptop computer, a tablet computer, a netbook computer, a personal computer (PC), a personal digital assistant (PDA), a desktop computer, or any programmable electronic device capable of receiving, sending, and processing data. In general, computer system 120 represents any programmable electronic device or combination of programmable electronic devices capable of executing machine readable program instructions and communications with various other computer systems (not shown). In another embodiment, computer system 120 represents a computing system utilizing clustered computers and components to act as a single pool of seamless resources. In general, computer system 120 can be any computing device or a combination of devices with access to various other computing systems (not shown) and is capable of executing partiality detection program 122, computer interface 124, and regression learning model 126. Computer system 120 may include internal and external hardware components, as described in further detail with respect to FIG. 6.

In this exemplary embodiment, partiality detection program 122, computer interface 124, and regression learning model 126 are stored on computer system 120. However, in other embodiments, partiality detection program 122, computer interface 124, and regression learning model 126 are stored externally and accessed through a communication network, such as network 110. Network 110 can be, for example, a local area network (LAN), a wide area network (WAN) such as the Internet, or a combination of the two, and may include wired, wireless, fiber optic or any other connection known in the art. In general, network 110 can be any combination of connections and protocols that will support communications between computer system 120, client device 130, and SAN 140, and various other computer systems (not shown), in accordance with desired embodiment of the present invention.

In the embodiment depicted in FIG. 1, partiality detection program 122, at least in part, has access to client application 132 and can communicate data stored on computer system 120 to client device 130, SAN 140, and various other computer systems (not shown). More specifically, partiality detection program 122 defines a user of computer system 120 that has access to data stored on client device 130 and/or database 144.

Partiality detection program 122 is depicted in FIG. 1 for illustrative simplicity. In various embodiments of the present invention, partiality detection program 122 represents logical operations executing on computer system 120, where computer interface 124 manages the ability to view these logical operations that are managed and executed in accordance with partiality detection program 122. In some embodiments, partiality detection program 122 represents a system that processes and analyzes data to detect partiality in computer decisions made based on that data.

Computer system 120 includes computer interface 124. Computer interface 124 provides an interface between computer system 120, client device 130, and SAN 140. In some embodiments, computer interface 124 can be a graphical user interface (GUI) or a web user interface (WUI) and can display, text, documents, web browsers, windows, user options, application interfaces, and instructions for operation, and includes the information (such as graphic, text, and sound) that a program presents to a user and the control sequences the user employs to control the program. In some embodiments, computer system 120 accesses data communicated from client device 130 and/or SAN 140 via a client-based application that runs on computer system 120. For example, computer system 120 includes mobile application software that provides an interface between computer system 120, client device 130, and SAN 140. In various embodiments, computer system 120 communicates the GUI or WUI to client device 130 for instruction and use by a user of client device 130.

In various embodiments, client device 130 is a computing device that can be a standalone device, a server, a laptop computer, a tablet computer, a netbook computer, a personal computer (PC), a personal digital assistant (PDA), a desktop computer, or any programmable electronic device capable of receiving, sending and processing data. In general, computer system 120 represents any programmable electronic device or combination of programmable electronic devices capable of executing machine readable program instructions and communications with various other computer systems (not shown). In another embodiment, computer system 120 represents a computing system utilizing clustered computers and components to act as a single pool of seamless resources. In general, computer system 120 can be any computing device or a combination of devices with access to various other computing systems (not shown) and is capable of executing client application 132 and client interface 134. Client device 130 may include internal and external hardware components, as described in further detail with respect to FIG. 6.

Client application 132 is depicted in FIG. 1 for illustrative simplicity. In various embodiments of the present invention client application 132 represents logical operations executing on client device 130, where client interface 134 manages the ability to view these various embodiments, and client application 132 defines a user of client device 130 that has access to data stored on computer system 120 and/or database 144.

Storage area network (SAN) 140 is a storage system that includes server application 142 and database 144. SAN 140 may include one or more, but is not limited to, computing devices, servers, server-clusters, web-servers, databases and storage devices. SAN 140 operates to communicate with computer system 120, client device 130, and various other computing devices (not shown) over a network, such as network 110. For example, SAN 140 communicates with partiality detection program 122 to transfer data between computer system 120, client device 130, and various other computing devices (not shown) that are not connected to network 110. SAN 140 can be any computing device or a combination of devices that are communicatively connected to a local IoT network, i.e., a network comprised of various computing devices including, but are not limited to computer system 120 and client device 130, to provide the functionality described herein. SAN 140 can include internal and external hardware components as described with respect to FIG. 6. Embodiments of the present invention recognize that FIG. 1 may include any number of computing devices, servers, databases, and/or storage devices, and the present invention is not limited to only what is depicted in FIG. 1. As such, in some embodiments some of the features of computer system 120 are included as part of SAN 140 and/or another computing device.

Additionally, in some embodiments, SAN 140 and computer system 120 represent, or are part of, a cloud computing platform. Cloud computing is a model or service delivery for enabling convenient, on demand network access to a shared pool of configurable computing resources (e.g., networks, network bandwidth, servers, processing, memory, storage, applications, virtual machines, and service(s) that can be rapidly provisioned and released with minimal management effort or interaction with a provider of a service. A cloud model may include characteristics such as on-demand self-service, broad network access, resource pooling, rapid elasticity, and measured service, can be represented by service models including a platform as a service (PaaS) model, an infrastructure as a service (IaaS) model, and a software as a service (SaaS) model, and can be implemented as various deployment models as a private cloud, a community cloud, a public cloud, and a hybrid cloud. In various embodiments, SAN 140 represents a database or website that includes, but is not limited to, generating predictions for large sets of data.

SAN 140 and computer system 120 are depicted in FIG. 1 for illustrative simplicity. However, it is to be understood that, in various embodiments, SAN 140 and computer system 120 can include any number of databases that are managed in accordance with the functionality of partiality detection program 122 and server application 142. In general, database 144 represents data and server application 142 represents code that provides an ability to use and modify the data. In an alternative embodiment, partiality detection program 122 can also represent any combination of the aforementioned features, in which server application 142 has access to database 144. To illustrate various aspects of the present invention, examples of server application 142 are presented in which partiality detection program 122 represents one or more of, but is not limited to, generating predictions for large sets of data.

In some embodiments, server application 142 and database 144 are stored on SAN 140. However, in various embodiments, server application 142 and database 144 may be stored externally and accessed through a communication network, such as network 110, as discussed above.

Embodiments of the present invention provide for a system that uses a regression machine learning model to perform determinations/predictions for a data set. More specifically, embodiments of the present invention identify partiality in the regression machine learning model's predictions, particularly with respect to specific values of specific attributes, and use various methods to help mitigate that partiality.

In various embodiments, partiality detection program 122 identifies whether two or more groups of data entries are receiving different prediction values based on the groups having different values of a particular attribute. In various embodiments of the present invention, certain ranges of prediction values generated by the regression machine learning model are identified as being “favorable.” In various embodiments, if the ratio of a favorable outcome of a first group of data entries having a first value of the particular attribute divided by the ratio of a favorable outcome of a second group of data entries having a second value of the particular attribute, or vice versa, is less than 0.8, for example, partiality detection program 122 determines that partiality may exist in the results of the regression machine learning model. In various embodiments, the data entries of the first group receive favorable predictions at a lower proportional rate than the data entries of the second group. In various embodiments, the data entries of the first group receive favorable predictions at a lower proportional rate than the data entries of the second group. Partiality detection program 122 then performs a perturbation analysis, where the value of the particular attribute is flipped between the first group and the second group having a first value of the particular attribute, and uses the results of the perturbation analysis to determine whether partiality actually exists.

Embodiments of the present invention provide that in some cases, the particular attribute may include a protected category (or protected class) including, but not limited to, age, gender, race, national origin, religion, etc., and that the system may identify groups of entries having values of the particular attribute that are receiving partial (that is, biased) predictions. For example, in one embodiment, where age—a protected class—is the particular attribute, if the ratio between the rate at which individuals under the age of twenty-five (25) are provided favorable home loan terms and the rate at which individuals greater than or equal to twenty-five (25) are provided favorable home loan terms is below 0.8, then individuals under the age of 25 are disparately impacted.

In various embodiments of the present invention, partiality detection program 122 receives input data that includes, but is not necessarily limited to, (i) a dataset, (ii) an identification of “favorable” and “unfavorable” ranges of prediction values for the dataset, (iii) a monitored group of data entries (a “first group”) of the dataset having a first value of a particular attribute, for which mostly unfavorable predictions are being generated, (iv) a reference group of data entries (a “second group”) of the dataset having a second value of the particular attribute, for which mostly favorable predictions are being generated, and (v) a partiality threshold, such as 0.8, indicating what amount of difference in favorable prediction values between the first group and the second group is considered acceptable. In various embodiments, the data entries of the first group receive favorable predictions at a lower proportional rate than the data entries of the second group.

In various embodiments, partiality detection program 122 perturbs (i.e., flips) the values of the particular attribute for the first and second groups of data entries, such that the first group of data entries have the second value for the particular attribute and the second group of data points have the first value for the particular attribute, and all other attribute values are kept the same. In various embodiments, the perturbed dataset is provided to a regression machine learning model to produce the regression machine learning model's output of the perturbed dataset. For example, if the first group of data entries, when provided to the regression machine learning model, produces mostly unfavorable predictions, but the perturbed first group, when provided to the regression machine learning model, produces mostly favorable predictions, then partiality detection program 122 determines that the regression machine learning model is not impartial with respect to the particular attribute and is disparately impacting the first group of data entries. Embodiments of the present invention further provide that partiality detection program 122 labels data entries that are disparately impacted as data entries that are receiving a partial/biased determination.

In various embodiments, partiality detection program 122 uses the data entries that have been labeled as disparately impacted as training data for building a binary classification model (or a “partiality detection model”), where the prediction generated by the partiality detection model is either “partial” or “impartial.” The partiality detection model is then used to detect and remove partiality, or bias, from a new data entry, as follows:

Rule One: if the specific attribute has the second value, from the reference group, then the entry is sent to regression learning model 126 and the prediction generated by regression learning model 126 is identified as an impartial prediction.

Rule Two: if the specific attribute has the first value, from the monitored group, then the entry is sent to regression learning model 126, and if regression learning model 126 returns a favorable prediction, then the prediction generated by regression learning model 126 is identified as an impartial prediction.

Rule Three: if the specific attribute has the first value, from the monitored group, and if regression learning model 126 predicts an unfavorable outcome, then partiality detection program 122 sends the entry to the partiality detection model, which determines whether the prediction generated by regression learning model 126 is partial. If the partiality detection model determines that the prediction generated by regression learning model 126 is impartial, then the prediction generated by regression learning model 126 is identified as impartial.

Rule Four: if the specific attribute has the first value, from the monitored group, and if regression learning model 126 predicts an unfavorable outcome, then partiality detection program 122 sends the entry to the partiality detection model, which determines whether the prediction generated by regression learning model 126 is partial. If the partiality detection model determines that the prediction generated by regression learning model 126 is partial, then partiality detection program 122 perturbs the value of the specific attribute so that it is the second value, from the reference group, and sends the entry with the perturbed value to regression learning model 126, and the prediction generated by regression learning model 126 is identified as an impartial prediction.

In various embodiments, partiality detection program 122 utilizes equation (1) to determine whether a specific value of the specific attribute of an original record is receiving a partial determination compared to the specific value of the specific attribute of the perturbed record.

$$\frac{\begin{matrix}( absolute value ( label value of original record - \\ average value of the perturbed records )\end{matrix}}{\begin{matrix}standard deviation \\ ( original nd perturbed records )\end{matrix}} \qquad Equation ( 1 )$$

In various embodiments, partiality detection program 122 optimizes regression learning model 126 to correct for unrealistic perturbations of values of the particular attribute. Embodiments of the present invention provide that various perturbations of the values of the particular attribute are outliers and may not exist within a realistic context of the first group and second group of data entries, the range of the regression model prediction, and the particular attribute. Embodiments of the present invention recognize that unrealistic perturbations lead to inaccuracies within the determinations of regression learning model 126, and embodiments of the present invention provide for solutions to such unrealistic perturbations, such as, but not limited to, an auto-encoder based approach and an expectation maximization based approach.

In various embodiments, partiality detection program 122 utilizes an auto-encoder to identify unrealistic perturbations of the values of first particular attribute. In various embodiments, partiality detection program 122 utilizes the training data provided to partiality detection model (i.e., the binary classification model) to generate an auto-encoder. In various embodiments, the auto-encoder represents an unsupervised learning algorithm that learns the distribution of the training data. In various embodiments, for a new data entry, the auto-encoder encodes the new data entry to an internal representation and then attempts to regenerate the new data entry. If the regenerated new data entry is different from the original new data entry, the new data entry is not from the same distribution as the training data. As such, if partiality detection program 122 provides the perturbed dataset to the auto-encoder, and an error occurs when the auto-encoder attempts to regenerate a particular perturbed entry of the perturbed dataset, partiality detection program 122 determines that the perturbed entry is unrealistic. In various embodiments, if the perturbed entry is determined to be unrealistic, then partiality detection program 122 does not send the perturbed entry to regression learning model 126 for a final, impartial determination (see Rule Four, above).

In various embodiments, partiality detection program 122 utilizes an expectation maximization based approach to find missing attribute values. The expectation maximization involves a two-step process, where, in the first step, the missing attribute value is estimated, and in the second step, an expectation maximization method is used to make a best guess for the missing attribute value. The two steps are repeated until the first step and the second step values converge within a threshold value of one another. In various embodiments, partiality detection program 122 utilizes the perturbed value of the specified attribute as the first step. In various embodiments, partiality detection program 122 utilizes the expectation maximization algorithm to predict the attribute value. In various embodiments, if the predicted attribute value is close within a threshold value to the perturbed attribute value, then the perturbed attribute value is valid. However, if the predicted attribute value from the expectation maximization algorithm is not within a threshold value to the perturbed attribute value, then the perturbed attribute value is not a valid value, and is not sent to regression learning model 126 for a final, impartial determination (see Rule Four, above).

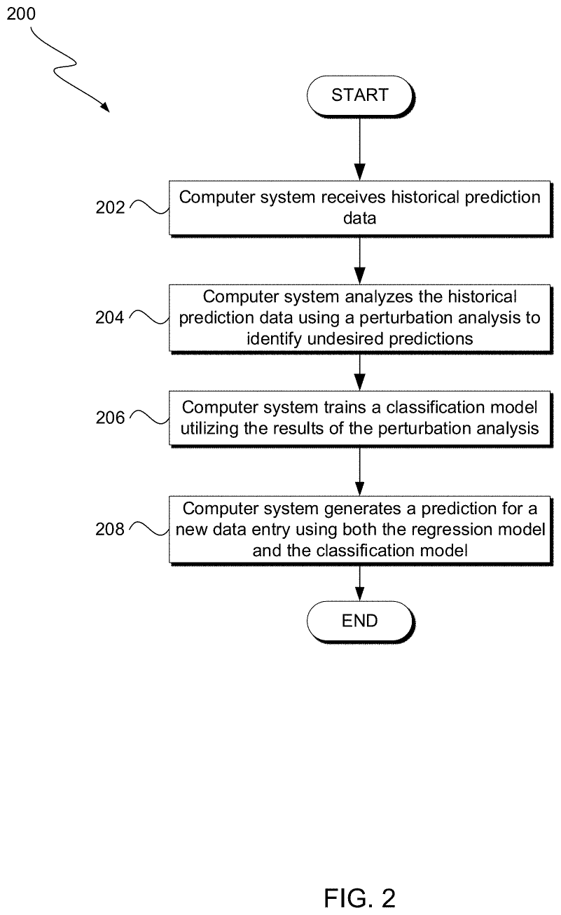

FIG. 2 is a flowchart, 200, depicting operations of partiality detection program 122 in computing environment 100, in accordance with an illustrative embodiment of the present invention. FIG. 2 also represents certain interactions between partiality detection program 122 and client application 132. In some embodiments, the operations depicted in FIG. 2 incorporate the output of certain logical operations of partiality detection program 122 executing on computer system 120. It should be appreciated that FIG. 2 provides an illustration of one implementation and does not imply any limitations with regard to the environments in which different embodiments may be implemented. Many modifications to the depicted environment may be made. In one embodiment, the series of operations in FIG. 2 can be performed in any order. In another embodiment, the series of operations, depicted in FIG. 2, can be terminated at any operation. In addition to the features previously mentioned, any operations, depicted in FIG. 2, can be resumed at any time. In various embodiments, partiality detection program 122 receives input data from a user of client device 130 to identify partiality within a set of data entries and to mitigate the partial determinations within regression learning model 126 by building a binary classification model in conjunction with regression learning model 126 to predict more impartial determinations of the output class.

In operation 202, partiality detection program 122 receives historical prediction data. In various embodiments, partiality detection program 122 accesses database 144 executing on SAN 140 and retrieves the historical prediction data, wherein the data entries of the first group receive favorable predictions at a lower proportional rate than the data entries of the second group, that includes: (i) a dataset having data entries, (ii) predictions generated for the data entries using a regression machine learning model, and (iii) an information pertaining to the dataset. In various embodiments, the information pertaining to the dataset includes: (i) an identification of “favorable” and “unfavorable” ranges of prediction values for the dataset, (ii) an identification of a monitored group of data entries (a “first group”) having a first value of a particular attribute, for which mostly unfavorable predictions are being generated, (iii) an identification of a reference group of data entries (a “second group”) dataset having a second value of the particular attribute, for which mostly favorable predictions are being generated, and (iv) a partiality threshold indicating what amount of difference in favorable prediction values between the monitored group and the reference group is considered acceptable. In various other embodiments, for example, the monitored group and reference group need not be identified, as the monitored group and the reference group may be identified by partiality detection program 122 based on an identification of the particular attribute, or on an analysis of which data entries generally receive “favorable” and “unfavorable” prediction values.

In operation 204, partiality detection program 122 analyzes the historical prediction data using a perturbation analysis to identify undesired/unacceptable predictions. In various embodiments, partiality detection program 122 identifies that the monitored group of data entries is receiving an unacceptable amount of “unfavorable” predictions as compared to the reference group, according to the partiality threshold. In various embodiments, partiality detection program 122 perturbs (i.e., flips) the value of the particular attribute of the monitored group and the reference group, such that the monitored group has the second value for the particular attribute and the reference group has the first value for the particular attribute, and all other attribute values are kept the same. In various embodiments, the perturbed monitored group is provided to regression learning model 126. For example, if the original monitored group of data entries (i.e., the monitored group of data entries before the perturbation), when provided to regression learning model 126 produces mostly unfavorable predictions (i.e., exceeds a second partiality threshold), but the perturbed monitored group of data entries, when provided to regression learning model 126, produces mostly favorable predictions, then partiality detection program 122 determines that regression learning model 126 is not impartial with respect to the values of the particular attribute and is disparately impacting data entries of the monitored group. In various embodiments, a first partiality threshold (i.e., mostly favorable) is used to determine whether an attribute is a candidate for perturbation, and a second partiality threshold (i.e., mostly unfavorable) would be used to determine whether the difference between the predictions of the first group and the predictions of the perturbed first group is considered undesired. Embodiments of the present invention further provide that partiality detection program 122 labels data entries that are disparately impacted as data entries that are receiving a partial/biased determination.

In operation 206, partiality detection program 122 trains a binary classification model utilizing the results of the perturbation analysis. In various embodiments, partiality detection program 122 provides the data entries that were labelled as part of the perturbation analysis—specifically, the data entries from the monitored group that were determined to be disparately impacted—to the binary classification model along with their respective labels. Using this training data, partiality detection program 122 trains the binary classification model to: (i) receive, as input, data entries with corresponding predictions, and (ii) produce, as output, labels indicating whether the predictions are partial/biased (such as labels of “partial” and “impartial”). Many known or yet to be known methods for training classification models, such as backpropagation, may be used. Additionally, in various other embodiments, other types of classification models may be used, as long as the result is a trained model configured to determine whether input predictions are partial/biased, or whether input predictions reach a certain threshold level or partialness/bias.

In operation 208, partiality detection program 122 generates a prediction for a new data entry using both the regression model and the binary classification model. In various embodiments, the binary classification model is used in combination with regression learning model 126 to further analyze, and potentially change, predictions generated by regression learning model 126 when those predictions are determined to be potentially susceptible to bias/partiality. For example, in various embodiments, partiality detection program 122 utilizes a set of rules that include, but are not necessarily limited to, Rule One, Rule Two, Rule Three, and Rule Four, as discussed above.

In an example embodiment, partiality detection program 122 identifies four new data entries for predictions in operation 208. In this example embodiment, the dataset includes data entries that represent individuals that receive work projects for assignment and completion, where the specific attribute is a “work group” field having two values: “group A” and “group B.” In this example embodiment, a user wishes to ensure an impartial distribution of work projects to the individuals in the two work groups. In this example embodiment, the monitored group includes the data entries of individuals in group A (i.e., data entries having the value of “group A” for the “work group” attribute”) and the reference group includes the data entries of individuals in group B (i.e., data entries having the value of “group B” for the “work group” attribute). Further, in this example embodiment, the predictions generated by regression learning model 126 are the number of work projects assigned to each of the individuals/data entries, where a desirable prediction is equal to or less than five (5) assigned work projects and an undesirable prediction is greater than five (5) work projects.

As mentioned above, in this example embodiment, partiality detection program 122 identifies four new data entries for predictions in operation 208. In this example embodiment, partiality detection program 122 identifies that the first new data entry, associated with Individual 1, includes the value “group B” for the “work group” attribute, which means that the first new data entry is in the reference group. In this example, because the first new data entry is in the reference group, Rule One applies, and as such partiality detection program 122 sends the first new data entry to regression learning model 126 for a prediction. Regression learning model 126 generates a prediction of four (4) work projects to assign to Individual 1, and partiality detection program 122 determines that the prediction generated for the first new data entry by regression learning model 126 is an acceptable/impartial prediction.

Continuing this example embodiment, partiality detection program 122 identifies that the second new data entry, associated with Individual 2, includes the value “group A” of the “work group” attribute, which means that the second new data entry is in the monitored group. In this example, partiality detection program 122 sends the second new data entry to regression learning model 126, and regression learning model 126 generates a prediction of five (5) work projects to assign to Individual 2. In this example, because the second new data entry is in the monitored group and has received a prediction identified as favorable (i.e., less than or equal to 5), Rule Two applies. As such, partiality detection program 122 determines that the prediction generated for the second new data entry by regression learning model 126 is an acceptable/impartial prediction.

Continuing this example embodiment, partiality detection program 122 identifies that the third new data entry, associated with Individual 3, includes the value “group A” of the “work group” attribute, which means that the third new data entry is in the monitored group. In this example, partiality detection program 122 sends the third new data entry to regression learning model 126, and regression learning model 126 generates a prediction of six (6) work projects to assign to Individual 3. Then, because the third new data entry is in the monitored group and has received a prediction identified as unfavorable (i.e., greater than 5), partiality detection program 122 sends the third new data entry to the binary classification model (i.e., the partiality detection model), which determines that the prediction is impartial. As such, Rule Three applies, and partiality detection program 122 determines that the prediction generated for the third new data entry by regression learning model 126 is an acceptable/impartial prediction.

Continuing the example embodiment, partiality detection program 122 identifies that the fourth new data entry, associated with Individual 4, includes the value “group A” of the “work group” attribute, which means that the fourth new data entry is in the monitored group. In this example, partiality detection program 122 sends the fourth new data entry to regression learning model 126, and regression learning model 126 generates a prediction of eight (8) work projects to assign to Individual 4. Then, because the fourth new data entry is in the monitored group and has received a prediction identified as unfavorable (i.e., greater than 5), partiality detection program 122 sends the fourth new data entry to the binary classification model (i.e., the partiality detection model). In this case, the binary classification model determines that the prediction for the fourth new data entry is biased/partial. As a result, Rule Four applies, and partiality detection program 122 perturbs the value of the “work group” attribute for the fourth new data entry—from “group A” to “group B”—and sends the fourth new data entry with the perturbed value to regression learning model 126. Partiality detection program 122 then determines that the prediction generated by regression learning model 126 using the perturbed value is an acceptable/impartial prediction.

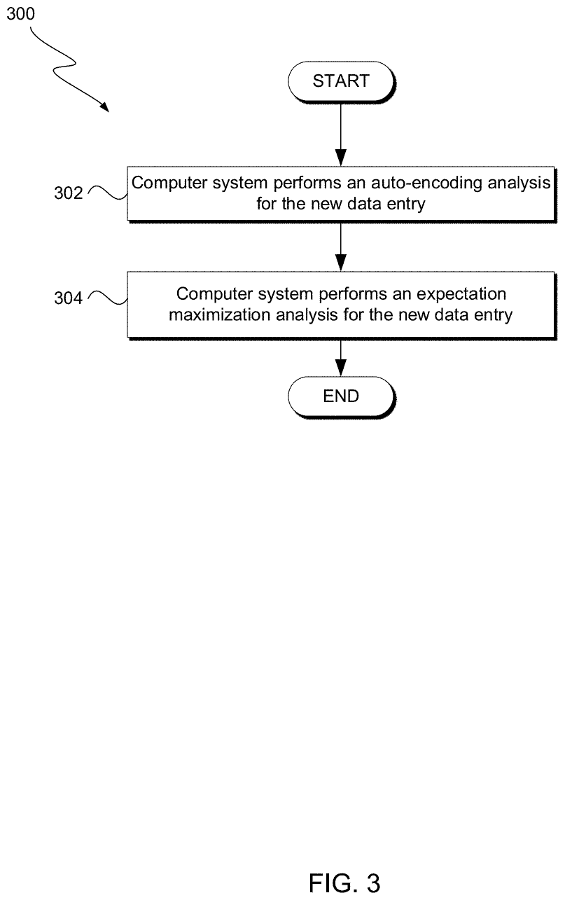

FIG. 3 is a flowchart, 300, depicting operations of partiality detection program 122 in computing environment 100, in accordance with an illustrative embodiment of the present invention. FIG. 3 also represents certain interactions between partiality detection program 122 and regression learning model 126. More specifically, FIG. 3, depicts combined overall operations, 300, of partiality detection program 122 executing on computer system 120. FIG. 3 also represents interactions between partiality detection program 122 and regression learning model 126. In some embodiments, some or all of the operations depicted in FIG. 3 represent logical operations of client application 132 executing on client device 130. In various embodiments, the series of operations 300 can be performed simultaneously with operations 300. It should be appreciated that FIG. 3 provides an illustration of one implementation and does not imply any limitations with regard to the environments in which different embodiments may be implemented. Many modification to the depicted environment may be made. In one embodiment, the series of operations, of flowchart 300, can be performed simultaneously. Additionally, the series of operations, in flowchart 300, can be terminated at any operation. In addition to the features previously mentioned, any operation, of flowchart 300, can be resumed at any time.

In various embodiments, partiality detection program 122 optimizes the method of FIG. 2 to avoid extraneous de-biasing in groups of new data entries. In various embodiments, for example, perturbing the value of the specific attribute of a new data entry to achieve an impartial prediction may be extraneous or unrealistic, and may lead to undesired effects. In an example embodiment, an extraneous or unrealistic perturbation would include, at least, the value of the monitored group of data entries represents an individual who is less than twenty-five (25) years of age and the value of the reference group of data entries represents an individual who is over the age of seventy (70) and the determination of the output class would be whether the individual is retired or not. In this second example embodiment, it would be an extraneous or unrealistic perturbation that the individual of the who is less than twenty-five (25) is retired. In these cases, when the generated prediction cannot be relied upon, embodiment of the present invention may choose to interrupt the method of FIG. 2. and avoid providing a prediction at all instead of providing an unreliable prediction.

In operation 302, partiality detection program 122 performs an auto-encoding analysis for the new data entry. Embodiments of the present invention provide that partiality detection program 122 provides the historical prediction data to regression learning model 126 and partiality detection program 122 analyzes the output from regression learning model 126. In various embodiments, partiality detection program 122 utilizes the historical prediction data to build an auto-encoder, where the auto-encoder identifies, at least, (i) the dataset having data entries, (ii) the predictions generated for the data entries using a regression machine learning model, and (iii) the information pertaining to the dataset. In various embodiments, regression learning model 126 represents an auto-encoder, wherein the auto-encoder represents an unsupervised learning algorithm that identifies the distribution of the historical prediction data and determines when outliers are present for the perturbed data of the new data entry. Additionally, structures of the auto-encoder include, but is not limited to, (i) spare, (ii) contractive, and (iii) feedforward non-recurrent. Embodiments of the present invention provide that the auto-encoder, executing as an unsupervised machine learning process, learns how to efficiently compress (i.e., reduced encoded representation) and encode the new data entry, where the auto-encoder further learns how to reconstruct the new data entry based on, at least, the reduced encoded representation to generate data that reaches a threshold value of similarity to the new data entry. In various embodiments, partiality detection program 122 selects the value of the specific attribute of the new data entry, encodes that value to an internal representation, and attempts to re-generate the selected value. In various embodiments, partiality detection program 122 perturbs the new data entry with the value of the specific attribute of the reference group and provides the perturbed new data entry to the auto encoder, where if the auto-encoder attempts to compress the perturbed new data entry and reconstructs the perturbed new data entry and does not receive a threshold value of similarity to the original perturbed new data entry (i.e., the original data point provided to the auto-encoder), then partiality detection program 122 determines that the perturbed new data entry is extraneous or unrealistic and is not utilized in the group of data entries to mitigate bias within regression learning model 126. In various embodiments, regression learning model 126 operates to reduce signal noise in the value of the data entry. In various embodiments, where regression learning model 126 reduces the signal noise, regression learning model 126 reconstructs the reduced signal noise to generate the reduced encoding representation as close as possible to the original input of the value of the new data entry.

In various embodiments, partiality detection program 122 trains regression learning model 126 by providing historical prediction data, where regression learning model 126 has an input layer, an output layer and one or more hidden layers connecting them, and where the output layer has the same number of nodes as in the input layer, with the purpose to reconstruct the input data as close as possible (i.e., minimizing the difference between the input and output).

In operation 304, partiality detection program 122 performs an expectation maximization analysis for the new data entry. In various embodiments, partiality detection program 122 perturbs the value of the specific attribute of the new data entry and provides the perturbed value to regression learning model 126. In various embodiments, regression learning model 126 generates an output value when regenerating the perturbed value of the specific attribute, and partiality detection program 122 determines that the output value from regression learning model 126 represents an error, where partiality detection program 122 further determines that the perturbed value of the specific attribute is extraneous and unrealistic. In various embodiments, partiality detection program 122 further determines to not provide the perturbed new data entry to regression learning model 126 for prediction generation.

In various embodiments, the expectation maximization analysis is utilized to find values for missing feature values. In various embodiments, partiality detection program 122 estimates a value of the specific attribute for the missing feature values, then partiality detection program 122 maximizes the missing feature values of the specific attribute by determining the best-fit estimation for the value of the specific attribute of the missing feature value. In various embodiments, the maximization estimation is an iterative process that is continued until a convergence is reached between the known attribute value and the missing feature values.

In various embodiments, the estimation maximization approach further represents an algorithm to estimate the missing value of the specific attribute. In various embodiments, partiality detection program 122 attempts to mitigate the bias within the new data entry for an impartial determination of a range of the value-based output. In various embodiments, partiality detection program 122 begins with a specific value of the specific attribute from the new data entry and executes the estimation maximization algorithm, if the returned specific value of the specific attribute for the missing new data entry is close to the specific value of the specific attribute of the monitored group, then the perturbed monitored group would be valid, and would be included to reduce mitigation in the regression machine learning model. However, in various embodiments, if partiality detection program 122 begins with a specific value of the specific attribute from the new data entry and executes the estimation maximization algorithm, if the returned specific value of the specific attribute for the missing new data entry is close to the specific value of the specific attribute of the reference group, then the perturbed new data entry would be invalid and partiality detection program 122 does not include the new data entry to reduce mitigation bias in regression learning model 126, where the invalid monitored group would lead to inaccuracies in the predictions of regression learning model 126 and would predict partial determinations for the monitored group.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

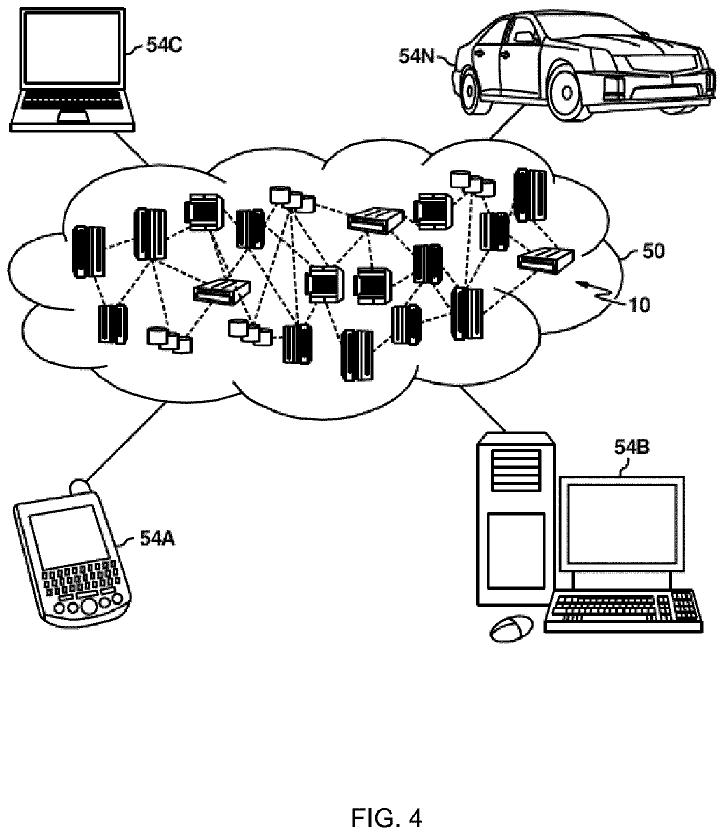

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

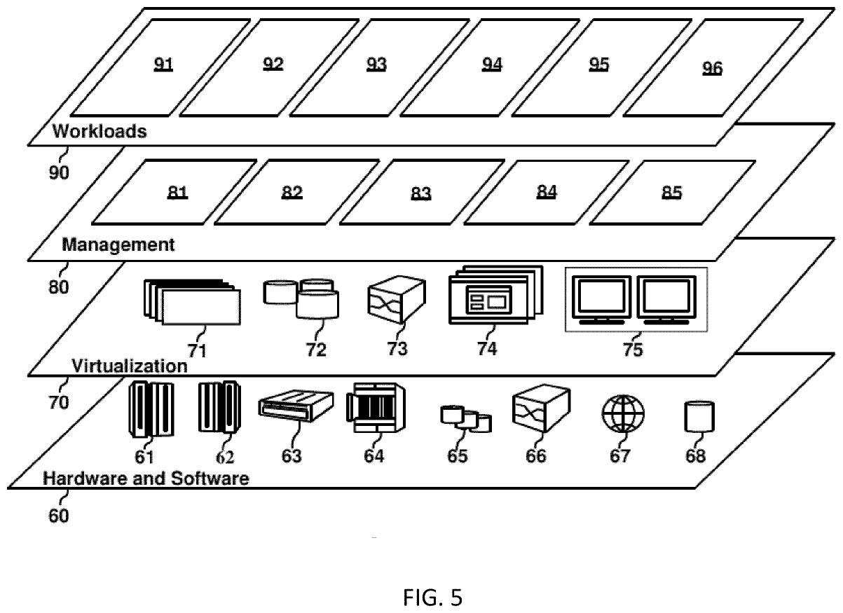

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing soothing output 96.

FIG. 6 depicts a block diagram, 600, of components of computer system 120, client device 130, and SAN 140, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computer system 120, client device 130, and SAN 140 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

Partiality detection program 122, computer interface 124, regression learning model 126, client application 132, client interface 134, server application 142, and database 144 are stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices, including resources of network 110. In these examples, communications unit 610 includes one or more network interface cards. Communications unit 610 may provide communications through the use of either or both physical and wireless communications links. Partiality detection program 122, computer interface 124, regression learning model 126, client application 132, client interface 134, server application 142, and database 144 may be downloaded to persistent storage 608 through communications unit 610.

I/O interface(s) 612 allows for input and output of data with other devices that may be connected to computing device 6XX. For example, I/O interface 612 may provide a connection to e6ternal devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., partiality detection program 122, computer interface 124, regression learning model 126, client application 132, client interface 134, server application 142, and database 144, can be stored on such portable computer-readable storage media and can be loaded onto persistent storage 608 via I/O interface(s) 612. I/O interface(s) 612 also connect to a display 620.

Display 620 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A computer-implemented method, the method comprising:
receiving, by one or more processors, historical prediction data, where the historical prediction data includes historical data and corresponding predictions generated for the historical data by a regression machine learning model;
identifying, by one or more processors, undesired predictions in the historical prediction data based, at least in part, on a perturbation analysis, where the perturbation analysis includes modifying an attribute of the historical data and using the regression machine learning model to generate predictions for the historical data with the modified attribute;
training, by one or more processors, a binary classification model to classify predictions as undesired, using the historical prediction data and the identified undesired predictions as training data; and
generating, by one or more processors, a prediction for a new data entry utilizing the regression machine learning model and the binary classification model.

2. The computer-implemented method of claim 1, wherein the identifying of the undesired predictions in the historical prediction data further comprises:
identifying, by one or more processors, a range of favorable prediction values for data entries of the historical data;
identifying, by one or more processors, a first partiality threshold representing an acceptable amount of difference in favorable prediction values resulting from different values of attributes of the data entries of the historical data; and
determining, by one or more processors, the attribute for modification in the perturbation analysis based, at least in part, on the range of favorable prediction values and the first partiality threshold.

3. The computer-implemented method of claim 2, wherein modifying the attribute of the historical data further comprises:
identifying, by one or more processors: (i) a first group of data entries of the historical data having a first set of values of the attribute, and (ii) a second group of data entries of the historical data having a second set of values of the attribute, wherein the data entries of the first group receive favorable predictions at a lower proportional rate than the data entries of the second group; and
perturbing, by one or more processors, the values of the attribute for the first group with the values of the attribute for the second group, resulting in a perturbed first group of data entries having values of the attribute in the second set of values.

4. The computer-implemented method of claim 3, wherein the identifying of the undesired predictions in the historical prediction data further comprises:
providing, by one or more processors, the perturbed first group of data entries to the regression machine learning model to generate predictions for the perturbed first group of data entries;
determining, by one or more processors, whether a difference in favorable prediction values between the first group of data entries and the perturbed first group of data entries exceeds a second partiality threshold; and
in response to determining that the difference in favorable prediction values between the first group of data entries and the perturbed first group of data entries exceeds the second partiality threshold, identifying the predictions generated for the first group of data entries in the historical data as undesired predictions.

5. The computer-implemented method of claim 3, wherein generating the prediction for the new data entry further comprises:
in response to the new data entry having a value of the attribute in the first set of values, sending, by the one or more processors, the new data entry to the regression machine learning model; and
in response to the regression machine learning model returning a prediction for the new data entry that is not in the range of favorable prediction values, sending the new data entry and the corresponding prediction returned by the regression machine learning model for the new data entry to the binary classification model.

6. The computer-implemented method of claim 5, wherein generating the prediction for the new data entry further comprises:
in response to the binary classification model not classifying the prediction returned by the regression machine learning model for the new data entry as undesired, using the prediction returned by the regression machine learning model for the new data entry as the generated prediction.

7. The computer-implemented method of claim 5, wherein generating the prediction for the new data entry further comprises:
in response to the binary classification model classifying the prediction returned by the regression machine learning model for the new data entry as undesired:
perturbing, by one or more processors, the value of the attribute of the new data entry so that the value is in the second set of values,
sending, by one or more processors, the new data entry with the perturbed value of the attribute to the regression machine learning model, and
using, by one or more processors, the prediction returned by the regression machine learning model for the new data entry with the perturbed value of the attribute as the generated prediction.

8. A computer program product, the computer program product comprising:
one or more computer-readable media and program instructions stored on the one or more computer-readable storage media, the stored program instructions comprising:
program instructions to receive historical prediction data, where the historical prediction data includes historical data and corresponding predictions generated for the historical data by a regression machine learning model;
program instructions to identify undesired predictions in the historical prediction data based, at least in part, on a perturbation analysis, where the perturbation analysis includes modifying an attribute of the historical data and using the regression machine learning model to generate predictions for the historical data with the modified attribute;
program instructions to train a binary classification model to classify predictions as undesired, using the historical prediction data and the identified undesired predictions as training data; and
program instructions to generate a prediction for a new data entry utilizing the regression machine learning model and the binary classification model.

9. The computer program product of claim 8, wherein the program instructions to identify the undesired predictions in the historical prediction data further comprise:
program instructions to identify a range of favorable prediction values for data entries of the historical data;
program instructions to identify a first partiality threshold representing an acceptable amount of difference in favorable prediction values resulting from different values of attributes of the data entries of the historical data; and
program instructions to determine the attribute for modification in the perturbation analysis based, at least in part, on the range of favorable prediction values and the first partiality threshold.

10. The computer program product of claim 9, wherein the program instructions to modify the attribute of the historical data further comprise:
program instructions to identify: (i) a first group of data entries of the historical data having a first set of values of the attribute, and (ii) a second group of data entries of the historical data having a second set of values of the attribute, wherein the data entries of the first group receive favorable predictions at a lower proportional rate than the data entries of the second group; and
program instructions to perturb the values of the attribute for the first group with the values of the attribute for the second group, resulting in a perturbed first group of data entries having values of the attribute in the second set of values.

11. The computer program product of claim 10, wherein the program instructions to identify the undesired predictions in the historical prediction data further comprise:
program instructions to provide the perturbed first group of data entries to the regression machine learning model to generate predictions for the perturbed first group of data entries;
program instructions to determine whether a difference in favorable prediction values between the first group of data entries and the perturbed first group of data entries exceeds a second partiality threshold; and
program instructions to, in response to determining that the difference in favorable prediction values between the first group of data entries and the perturbed first group of data entries exceeds the second partiality threshold, identify the predictions generated for the first group of data entries in the historical data as undesired predictions.

12. The computer program product of claim 10, wherein the program instructions to generate the prediction for the new data entry further comprise:
program instructions to send the new data entry to the regression machine learning model, in response to the new data entry having a value of the attribute in the first set of values; and
program instructions to send the new data entry and the corresponding prediction returned by the regression machine learning model for the new data entry to the binary classification model, in response to the regression machine learning model returning a prediction for the new data entry that is not in the range of favorable prediction values.

13. The computer program product of claim 12, wherein the program instructions to generate the prediction for the new data entry further comprise:
program instructions to use the prediction returned by the regression machine learning model for the new data entry as the generated prediction, in response to the binary classification model not classifying the prediction returned by the regression machine learning model for the new data entry as undesired.

14. The computer program product of claim 12, wherein the program instructions to generate the prediction for the new data entry further comprise:
program instructions to, in response to the binary classification model classifying the prediction returned by the regression machine learning model for the new data entry as undesired:
perturb the value of the attribute of the new data entry so that the value is in the second set of values,
send the new data entry with the perturbed value of the attribute to the regression machine learning model, and
use the prediction returned by the regression machine learning model for the new data entry with the perturbed value of the attribute as the generated prediction.

15. A computer system, the computer system comprising:
one or more processors;
one or more computer readable storage medium; and
program instructions stored on the computer readable storage medium for execution by at least one of the one or more processors, the stored program instructions comprising:
program instructions to receive historical prediction data, where the historical prediction data includes historical data and corresponding predictions generated for the historical data by a regression machine learning model;
program instructions to identify undesired predictions in the historical prediction data based, at least in part, on a perturbation analysis, where the perturbation analysis includes modifying an attribute of the historical data and using the regression machine learning model to generate predictions for the historical data with the modified attribute;
program instructions to train a binary classification model to classify predictions as undesired, using the historical prediction data and the identified undesired predictions as training data; and
program instructions to generate a prediction for a new data entry utilizing the regression machine learning model and the binary classification model.

16. The computer system of claim 15, wherein the program instructions to identify the undesired predictions in the historical prediction data further comprise:
program instructions to identify a range of favorable prediction values for data entries of the historical data;
program instructions to identify a first partiality threshold representing an acceptable amount of difference in favorable prediction values resulting from different values of attributes of the data entries of the historical data; and
program instructions to determine the attribute for modification in the perturbation analysis based, at least in part, on the range of favorable prediction values and the first partiality threshold.

17. The computer system of claim 16, wherein the program instructions to modify the attribute of the historical data further comprise:
program instructions to identify: (i) a first group of data entries of the historical data having a first set of values of the attribute, and (ii) a second group of data entries of the historical data having a second set of values of the attribute, wherein the data entries of the first group receive favorable predictions at a lower proportional rate than the data entries of the second group; and
program instructions to perturb the values of the attribute for the first group with the values of the attribute for the second group, resulting in a perturbed first group of data entries having values of the attribute in the second set of values.

18. The computer system of claim 17, wherein the program instructions to identify the undesired predictions in the historical prediction data further comprise:
program instructions to provide the perturbed first group of data entries to the regression machine learning model to generate predictions for the perturbed first group of data entries;
program instructions to determine whether a difference in favorable prediction values between the first group of data entries and the perturbed first group of data entries exceeds a second partiality threshold; and
program instructions to, in response to determining that the difference in favorable prediction values between the first group of data entries and the perturbed first group of data entries exceeds the second partiality threshold, identify the predictions generated for the first group of data entries in the historical data as undesired predictions.

19. The computer system of claim 17, wherein the program instructions to generate the prediction for the new data entry further comprise:
program instructions to send the new data entry to the regression machine learning model, in response to the new data entry having a value of the attribute in the first set of values; and
program instructions to send the new data entry and the corresponding prediction returned by the regression machine learning model for the new data entry to the binary classification model, in response to the regression machine learning model returning a prediction for the new data entry that is not in the range of favorable prediction values.

20. The computer system of claim 18, wherein the program instructions to generate the prediction for the new data entry further comprise:
program instructions to use the prediction returned by the regression machine learning model for the new data entry as the generated prediction, in response to the binary classification model not classifying the prediction returned by the regression machine learning model for the new data entry as undesired.
